(19) United States
(12) Patent Application Publication
(10) Pub. No.: US 2005/0167625 A1
(43) Pub. Date: Aug. 4, 2005

(54) Remotely controllable fluid control valve

(76) Inventor: Ferrell Deen, Wapato, WA (US)

Correspondence Address: Law Office of Timothy M. Barlow, P.O. Box 64775, Tucson, AZ, 85728-4775, US

(21) Appl. No.: 10/770,766

(22) Filed: Feb. 3, 2004

(51) Int. Cl. F16K 31/02

(52) U.S. Cl. 251/129.04; 239/69

(57) ABSTRACT

A remotely controllable fluid control valve includes a solenoid valve body with an inlet, an outlet, a solenoid mechanism and a power source, a wireless control receiver, and a wireless control transmitter. The solenoid mechanism is oriented to controllably interrupt the fluid connection between the inlet and the outlet. The power source is attached to the solenoid mechanism and the wireless control receiver to permit a user to control the position of the solenoid mechanism and the flow of water through the valve with the wireless control transmitter.

### BACKGROUND OF THE INVENTION

1. Field of the Invention

The present invention relates to valves for controlling the flow of fluids, and more particularly to a remotely controllable fluid control valve.

2. Description of the Related Art

Water and fluid control valves are well known. They have been around as long as plumbing has existed. Several different control mechanisms are used, depending upon the application. In household and most commercial applications, valves are manually controlled. Irrigation systems or automatic sprinklers systems use electrically controlled valves that are hardwired to a timer. In industrial and chemical processing facilities, many of the water and chemical control valves are electrically controlled via a hardwired control system. Actuation is usually computer controlled to meet the needs of the industrial or chemical process. Wireless control is unacceptable in many of these applications for many reasons. One reason is that tremendous number of valves would require a tremendous number of discrete frequencies, as well as personnel and resources to manage those frequencies. In addition, there may be a great potential for signal interference or signal loss due to structural materials or other equipment. Further, there may be unacceptable risks from outside signals interfering with equipment.

In a household environment, there are few critical operations involving the use of plumbing. Usually, household plumbing provides only water. Household water is directed toward the kitchen, laundry, bathroom, and exterior hose bibs, spigots and irrigation systems. For most of these uses, the water flow is easily controlled by a user because the water use is in close proximity to the control valve. This includes the kitchen sink, bathrooms and laundry facilities. However, exterior water spigots introduce a unique element to water use—distance from the control valve. Users are quite often situated remotely from a spigot or control valve due to the use of a garden hose or other water conduit. When using a garden hose, the user must physically move to the spigot or control valve to control water pressure and flow in the hose. The user may attach a nozzle or other manual shutoff to the hose, but these would not be effective where the user wants to operate a sprinkler or similar device and wants to avoid getting wet. The user would need to turn off the water at the spigot before moving or adjusting the sprinkler.

Another use for a water hose is to supply water for washing a car, construction or home improvement projects. For example, water is necessary when mixing concrete, but it is not practical to use the water right from the spigot. It is preferable to mix concrete close to the work site, to minimize the movement of heavy concrete and to avoid a mess close to the house or other building. A nozzle could be used, but is not necessarily a good choice. A nozzle delivers very high velocity water that could cause the concrete to splash or spill.

Modern garden hoses are very tough, but leaving them pressurized for long periods wears them out quickly. A better option would be to depressurize the hose at the spigot. Water would still be instantly available, and the wear and tear on the hose is negligible. Thus, what is needed is a water control valve that does not interfere with the normal use of a spigot or other water control valve, and that permits a user to control the valve and the flow of water from a distance.

U.S. Pat. No. 6,374,846, issued to Charles R. DeSmet on Apr. 23, 2002, describes a system for excercising the control valve for a water shut-off valve. However, it operates automatically and requires a flow sensor.

U.S. Pat. No. 5,971,011, issued to Stephen Jeffery Price on Oct. 26, 1999, teaches a water shut-off valve and leak detection system. However, the device operates automatically and requires a flow sensor.

U.S. Pat. No. 4,589,435, issued to Donald C. Aldrich on May 20, 1986, describes a water shutoff valve. However, the device operates automatically and requires a flow sensor.

U.S. Pat. No. 4,736,763, issued to George L. Britton et al. on Apr. 12, 1988, teaches an automatic device for the detection and shutoff of unwanted liquid flow in pipes. However, the device operates automatically and requires a flow sensor.

None of the above inventions and patents, taken either singularly or in combination, is seen to describe the instant invention as claimed. Thus a remotely controllable fluid control valve solving the aforementioned problems is desired.

### SUMMARY OF THE INVENTION

The device is a fluid control valve, and more specifically a remotely controllable fluid control valve that includes a solenoid valve body, a solenoid mechanism inside the valve body, a power source attached to the valve body and the solenoid mechanism, a wireless control receiver attached to the power supply and the solenoid mechanism, and a wireless control transmitter in wireless communication with the wireless control receiver to control the fluid flow through the fluid control valve. The valve body includes an inlet and an outlet. The inlet and outlet are connected through the valve body to permit fluid flow through the valve body. The solenoid mechanism is oriented to controllably interrupt the connection between the inlet and the outlet upon actuation of the solenoid via the wireless control receiver.

The fluid control valve is attached to a water supply, such as a household hose bib or spigot, permitting a user to remotely control the flow of water from the valve. A garden hose or other water conduit may be attached to the outlet side of the fluid control valve to direct water where the user desires. Thus attached, the user may remotely control the flow of water to a sprinkler, irrigation system or other water use. The user may suspend the flow of water to the sprinkler or other water use to permit the user to make adjustments without getting wet, wasting water, or making a long trip back to a hose bib or spigot.

Accordingly, it is a principal object of the invention to disclose a fluid control valve that allows a user to remotely control the flow of fluid from the valve.

It is another object of the invention to teach a remote-controlled fluid control valve that allows a user to remotely control the flow of water to a water distribution system.

It is a further object of the invention to disclose a remote-controlled fluid control valve that permits a user to adjust or manipulate a fluid distribution system without getting wet.

Still another object of the invention is to teach a remotely controllable fluid control valve that permits a user to adjust or manipulate a fluid distribution system without travelling to the valve for each adjustment.

Yet another object of the invention is to disclose a remotely controllable fluid control valve that may be individually controlled within a plurality of remotely controllable fluid control valves.

Yet another object of the invention is to teach a plurality of remotely controllable fluid control valves can be controlled from a single remote control transmitter.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a remotely controllable fluid control valve, attached to a hose bib, according to the present invention.

FIG. 2 is a perspective view of a remotely controllable fluid control valve with a remote control, according to the present invention.

FIG. 3 is a perspective view of the remotely controllable fluid control valve with a remote control, for threadless attachment to a water supply, according to the present invention.

Similar reference characters denote corresponding features consistently throughout the attached drawings.

### DETAILED DESCRIPTION OF THE PREFERRED EMBODIMENTS

The present invention is a fluid control valve, more specifically a remotely controllable fluid control valve.

The remotely controllable fluid control valve is made up of a center panel, a plurality of leaves, and a plurality of straps.

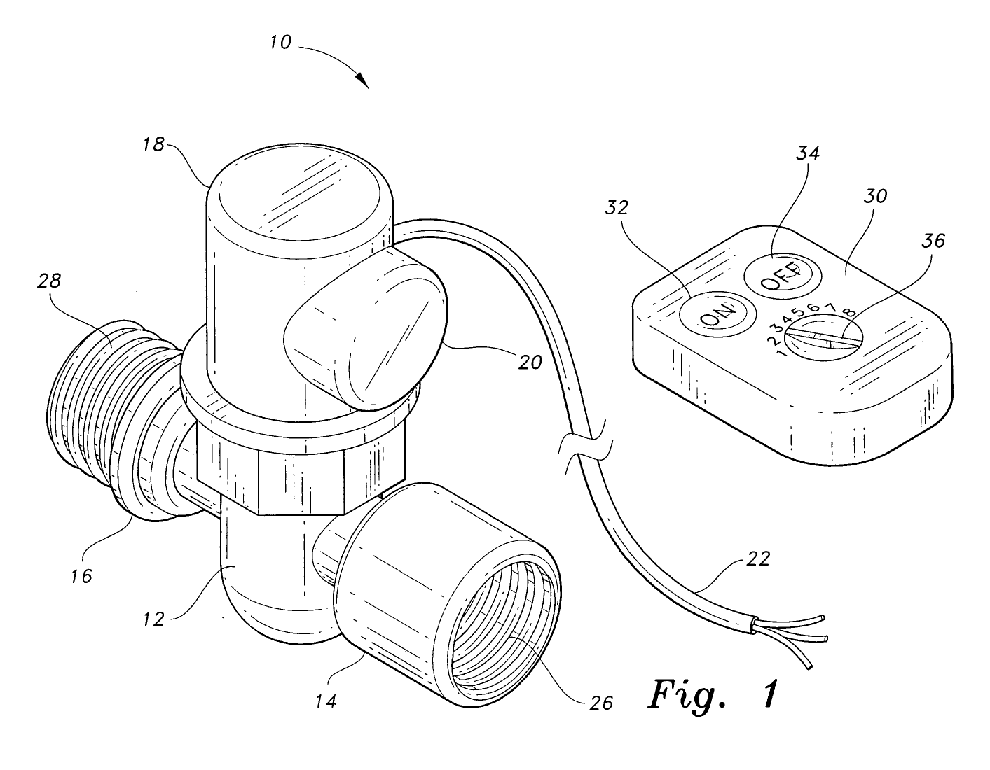

FIG. 1 is a perspective views of a remotely controllable fluid control valve, according to the present invention. The remote controlled valve 10 includes a valve body 12 with an inlet 14 and an outlet 16. The inlet 14 and outlet 16 form a continuous conduit through the valve body 12 SO that fluids may controllably flow through the valve body 12. A solenoid mechanism 18 is attached to the valve body 12 and includes a plunger (not shown) to selectively and controllably interrupt the continuous fluid conduit through the valve body 12 between the inlet 14 and the outlet 16. A wireless receiver 20 is attached to the valve body 12 and the solenoid 18. A power cable 22 is attached to the wireless receiver 20, and the wireless receiver 20 provides power to the solenoid 18. A wireless transmitter 24 is in wireless communication with the wireless receiver 20 and provides control signals to the wireless receiver 20.

The remotely controllable valve 10 comes is several variations. In one embodiment, the inlet 14 includes an internally threaded section 26. The internally threaded section 26 provides the remotely controllable valve with the ability to attach to an externally-threaded fluid conduit, such as a hose bib or spigot. When used in this manner the power cable 22 is routed to a power supply. This may be an outdoor power supply or one that is indoors. For most applications, the power cable 22 could be routed to an outdoor electrical outlet, or the power cable 22 can be routed through a wall along a water supply pipe to an indoor electrical outlet. The solenoid 18 may be one that operates from alternating current (AC) or direct current (DC). In the case of DC power, the DC power may be from batteries, an AC-powered transformer, solar panels or other sources. In one embodiment, the outlet 16 includes an externally threaded section 28. This permits a user to attach a threaded fluid conduit, such as a garden hose.

In use, the user has a wireless transmitter 30 to command the flow of water through the remotely controlled valve 10. In one embodiment, the wireless transmitter 30 includes an on button 32 and an off button 34. A wireless transmitter 30 of this type is suitable for controlling a single valve or a plurality of valves operating on a single frequency or signal. In another embodiment, the wireless transmitter 30 has an on button 26, an off button 28 and a selector 36 that the user can choose which valve to operate from a plurality of remotely controllable valves. For maximum flexibility the wireless transmitter 30 and wireless receiver 20 have several frequencies and channels to choose from. For example, the General Electric model number RF106RXPS is a handheld, battery-powered, programmable remote control unit with eight channels and four codes. In this manner, at least eight remotely controllable valves 10 could be controlled from this single wireless transmitter 30.

When the user presses the on button 32, a radio frequency signal is transmitted by the wireless transmitter 30. The wireless receiver 20 receives the signal and commands the solenoid 18 to position the plunger in a position of non-interference within the continuous fluid conduit through the valve body 12. In one embodiment, the solenoid 18 and plunger are in a normally open mode. This means that in the absence of power to the solenoid 18 the plunger does not interfere with the fluid conduit through the valve body 12. Thus, in this embodiment where the remote controlled valve 10 is normally open, when the user presses the off button 34, the radio frequency signal transmitted from the wireless transmitter 30 to the wireless receiver 20 applies power to the solenoid 18 which moves the plunger to a position of interference within the fluid conduit of the valve body. This stops the flow through the remote controlled valve 10. When the user presses the on button 32 the signal from the wireless transmitter 30 to the wireless receiver 20 removes power from the solenoid to moves the plunger to a position of non-interference within the fluid conduit of the valve body 12.

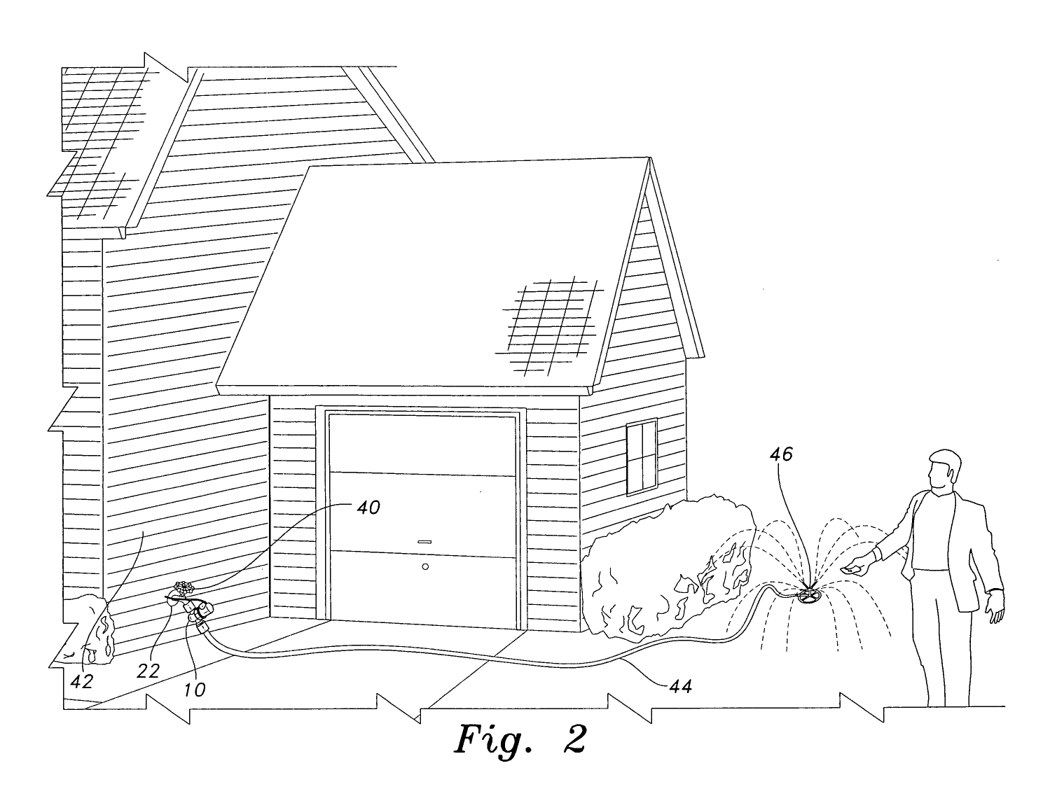

FIG. 2 is a perspective view of a remotely controllable fluid control valve with a remote control, according to the present invention. FIG. 2 shows a remotely controlled valve 10 in use in a residential environment. The remotely controlled valve 10 is attached to a hose bib or spigot 40 attached to a wall 42. A power cable 22 is attached to the remote-controlled valve 10 and is routed through the wall 42 along the water supply pipe to reach an interior power source. Alternatively, the power cable 22 could be attached to an exterior power source, or a battery or solar panel could be used to eliminate wiring hassles. One end of a garden hose 44 is attached to the remote-controlled valve 10, with a sprinkler 46 attached to the other end of the hose 44.

In this configuration, with the remote-controlled valve 10 attached to a spigot 40, it is logical that the remote-controlled valve 10 have a solenoid 18 constructed so that the plunger is normally open. The remote-controlled valve 10 is not the primary water control means unless the spigot 40 is broken. In this embodiment, the remote-controlled valve 10 is simply meant to interrupt the water flow.

Shown here a user is watering a garden or lawn with a sprinkler 46. After a brief time of watering the user must adjust the position of the sprinkler 46. If the user does not have an assistant and does not want to get wet, the process can be quite lengthy. Without the remote-controlled valve 10, the user would be required to walk to the spigot 40 and turn the water off. Then the user would need to walk back to the sprinkler to adjust its position. After adjustment, the user needs to go back to the spigot to turn the water on again. Finally, the user must return to the sprinkler 46 to see if the spray pattern or water pressure are acceptable. If the are not acceptable, the user will need to go back to the spigot 40 and repeat the necessary parts of the process. The remote-controlled valve 10 eliminates these hassles.

With an remote-controlled valve 10 installed between the spigot 40 and the garden hose 44, the user simply presses the off button 34 to turn off the water flow. Next, the user adjusts the position of the sprinkler 46 and presses the on button 32. The water pressure and flow rate are not affected by this process. Thus, the water pressure and flow return to the original levels as before the remote-controlled valve 10 was closed.

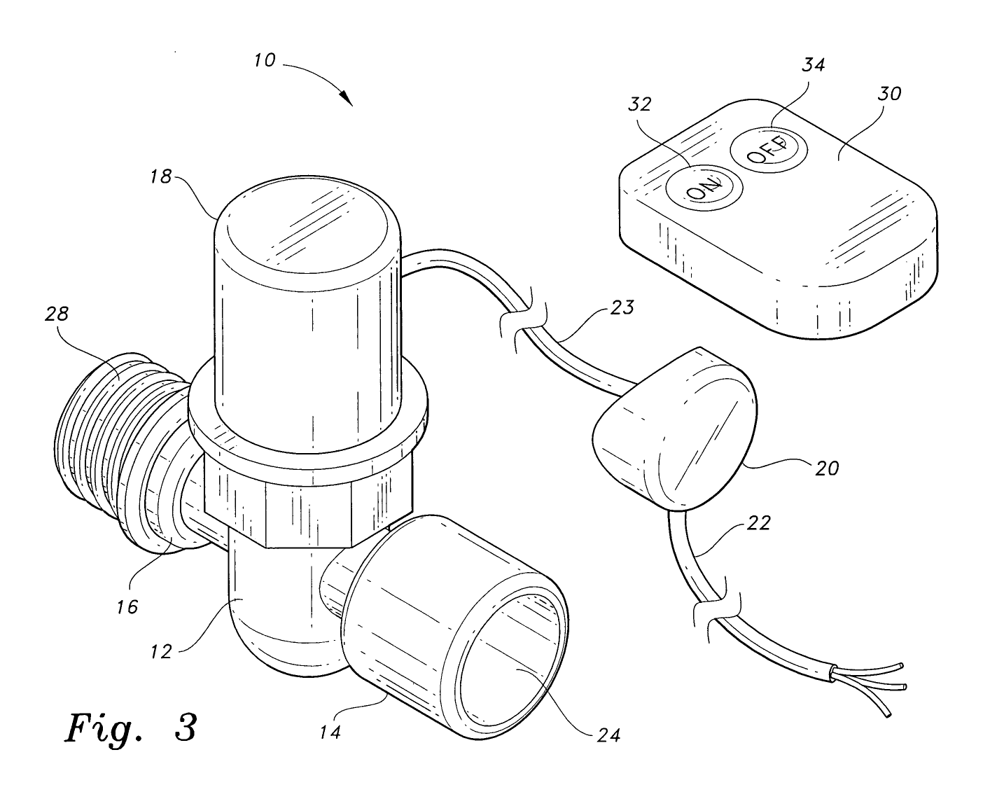

FIG. 3 is a perspective view of the remotely controllable fluid control valve with a remote control, for threadless attachment to a water supply, according to the present invention. The remote controlled valve 10 includes a valve body 12 with an inlet 14 and an outlet 16. The inlet 14 and outlet 16 form a continuous conduit through the valve body 12 so that fluids may controllably flow through the valve body 12. A solenoid mechanism 18 is attached to the valve body 12 and includes a plunger (not shown) to selectively and controllably interrupt the continuous fluid conduit through the valve body 12 between the inlet 14 and the outlet 16. A solenoid cable 23 is attached to the solenoid 18 and is removably attached to a wireless receiver 20. A power cable 22 is attached to the wireless receiver 20 and the wireless receiver 20 provides power to the solenoid 18 via the solenoid cable 23. A wireless transmitter 24 is in wireless communication with the wireless receiver 20 and provides control signals to the wireless receiver 20.

In this embodiment, the inlet 14 has a smooth interior and is suitable for threadless attachment to a fluid conduit, such as a metal or plastic pipe. In this example, the remote-controlled valve 10 is the primary fluid control means attached to the pipe. When used in this manner the power cable 22 is routed to a power supply. This may be an outdoor power supply or one that is indoors. For most applications, the power cable 22 could be routed to an outdoor electrical outlet, or the power cable 22 can be routed through a wall along a water supply pipe to an indoor electrical outlet. The solenoid 18 may be one that operates from alternating current (AC) or direct current (DC). In the case of DC power, the DC power may be from batteries, an AC-powered transformer, solar panels or other sources. In one embodiment, the outlet 16 includes an externally threaded section 28. This permits a user to attach a threaded fluid conduit, such as a garden hose.

In use, the user has a wireless transmitter 30 to command the flow of water through the remotely controlled valve 10. In one embodiment, the wireless transmitter 30 includes an on button 32 and an off button 34. A wireless transmitter 30 of this type is suitable for controlling a single valve or a plurality of valves operating on a single frequency or signal. In another embodiment, the wireless transmitter 30 has an on button 26, an off button 28 and a selector 36 (see FIG. 1) so that the user can choose which valve to operate from a plurality of remotely controllable valves. For maximum flexibility the wireless transmitter 30 and wireless receiver 20 have several frequencies and channels to choose from. For example, the General Electric model number RF106RXPS is a handheld, battery-powered, programmable remote control unit with eight channels and four codes. In this manner, at least eight remotely controllable valves 10 could be controlled from this single wireless transmitter 30.

When the user presses the on button 32, a radio frequency signal is transmitted by the wireless transmitter 30. The wireless receiver 20 receives the signal and commands the solenoid 18 to position the plunger in a position of non-interference within the continuous fluid conduit through the valve body 12. In this embodiment, the solenoid 18 and plunger are in a normally closed mode. This means that in the absence of power to the solenoid 18 the plunger interferes with the fluid conduit through the valve body 12. Fluids cannot flow through the remote-controlled valve 10 in this situation. Thus, in this embodiment where the remote controlled valve 10 is normally closed, when the user presses the off button 34, the radio frequency signal transmitted from the wireless transmitter 30 to the wireless receiver 20 removes power from the solenoid 18. In the absence of power to the solenoid 18, the plunger will move to a position of interference within the fluid conduit of the valve body 12 to stop the flow of fluids through the remote-controlled valve 10. When the user presses the on button 32, the signal from the wireless transmitter 30 to the wireless receiver 20 applies power to the solenoid to move the plunger to a position of non-interference within the fluid conduit of the valve body 12.

This variation of the remote-controlled valve 10 with a threadless connection to a water supply and that is normally closed, is uniquely suited to uses not appropriate where the remote-controlled valve 10 is normally open. For example, a remote-controlled valve 10 that is normally closed would prevent water loss if power is lost, because the remote-controlled valve 10 would automatically close. Of course, the opposite effect may be desired where some water or fluid flow is required to perform some important or critical function.

An remote-controlled valve 10 has many uses within a home or business, including control of fluid into and out of a boiler system, radiant heat system, and irrigation system and sprinkler systems. A remote-controlled valve 10 has numerous uses, including in the master water control valve to a home or business. If the remote-controlled valve 10 is of the normally open variety, the valve could be used by a plumber to save time in shutting off a water supply before beginning work. With the simply press of a button, the water supply may be turned off, allowing the plumber to depressurize and drain the plumbing so that repairs may be made safely. This same process could be accomplished with an irrigation system as well.

It is to be understood that the present invention is not limited to the embodiments described above, but encompasses any and all embodiments within the scope of the following claims.

1. A remotely controllable fluid control valve comprising:
a solenoid valve body, further comprising an inlet connected to an outlet through the valve body,
a solenoid mechanism oriented to controllably interrupt the connection between the inlet and the outlet, and a power source attached to the solenoid mechanism;
a wireless control receiver attached to the solenoid valve body, the solenoid mechanism and the power source; and
a wireless control transmitter in wireless communication with the wireless control receiver wherein the fluid control valve is normally open such that the fluid control valve automatically opens in the absence of power to the solenoid.

2. The remotely controllable fluid control valve of claim 1, wherein the solenoid mechanism is normally closed.

3. The remotely controllable fluid control valve of claim 1, wherein the solenoid mechanism is normally open.

4. The remotely controllable fluid control valve of claim 1, wherein the inlet comprises a threaded region around an internal circumference for removable attachment to a water supply having a mating threaded region.

5. The remotely controllable fluid control valve of claim 1, wherein the inlet is threadlessly attached to a water supply.

6. The remotely controllable fluid control valve of claim 1, wherein the outlet comprises a threaded region around an external circumference for removable attachment to a water conduit having a mating threaded region.

7. The remotely controllable fluid control valve of claim 6, wherein the water conduit is a garden hose.

8. The remotely controllable fluid control valve of claim 1, wherein the power source is an alternating current power supply.

9. The remotely controllable fluid control valve of claim 1, wherein the power source is a direct current power supply.

10. The remotely controllable fluid control valve of claim 1, wherein the direct current power supply is derived from an alternating current transformer.

11. The remotely controllable fluid control valve of claim 1, wherein the direct current power supply is derived from a battery.

12. The remotely controllable fluid control valve of claim 1, wherein the wireless control receiver is operable on two or more frequencies.

13. The remotely controllable fluid control valve of claim 1, wherein the wireless control transmitter is operable on two or more frequencies.

14. The remotely controllable fluid control valve of claim 13, wherein the wireless control transmitter is capable of controlling two or more remotely controllable fluid control valves independently.

15. The remotely controllable fluid control valve of claim 1, wherein the wireless control receiver is attached to the solenoid valve body via a solenoid power cord.

16. A remotely controllable fluid control valve comprising:
a solenoid valve body, further comprising a female-threaded inlet connected to a male-threaded outlet through the valve body, wherein the inlet may be removably attached to a water supply, a normally-closed solenoid mechanism oriented to controllably interrupt the connection between the inlet and the outlet, and a power source attached to the solenoid mechanism;
a wireless control receiver attached to the solenoid valve body, the solenoid mechanism and the power source; and
a wireless control transmitter in wireless communication with the wireless control receiver wherein the fluid control valve is normally closed such that the fluid control valve automatically closes in the absence of power to the solenoid.
